(19) United States
(12) Patent Application Publication
(10) Pub. No.: US 2021/0089182 A1
(43) Pub. Date: Mar. 25, 2021

(54) USER INTERFACE PROVIDED BASED ON TOUCH INPUT SENSORS

(71) Applicant: Sentons Inc., Grand Cayman (KY)

(72) Inventors: Samuel W. Sheng, Saratoga, CA (US); Lapoe E. Lynn, Los Altos, CA (US)

(21) Appl. No.: 17/030,217

(22) Filed: Sep. 23, 2020

Related U.S. Application Data
(60) Provisional application No. 62/905,997, filed on Sep. 25, 2019.

(51) Int. Cl. G06F 3/041; G06F 3/0488; G06F 3/01

(52) U.S. Cl. CPC G06F 3/04144; G06F 3/043; G06F 3/016; G06F 3/04886

(57) ABSTRACT

A system including sensors and a processor is described. The sensors are configured to sense force. The processor is configured to receive force measurements from the sensors and identify touch locations based on the force measurements. The processor is further configured to provide at least one user interface element based on the touch locations.

### CROSS REFERENCE TO OTHER APPLICATIONS

This application claims priority to U.S. Provisional Patent Application No. 62/905,997 entitled HAPTICS USING TOUCH INPUT SENSORS filed Sep. 25, 2019 which is incorporated herein by reference for all purposes.

### BACKGROUND OF THE INVENTION

Electronic devices such as smartphones, tablet computers, and wearables typically include a metal and/or plastic housing to provide protection and structure to the devices. The housing often includes openings to accommodate physical buttons that are utilized to interface with the device. However, there is a limit to the number and types of physical buttons that are able to be included in some devices due to physical, structural, and usability constraints. For example, physical buttons may consume too much valuable internal device space and provide pathways where water and dirt may enter a device to cause damage. Consequently, other mechanisms for allowing a user to interacting with electronic devices are desired.

### BRIEF DESCRIPTION OF THE DRAWINGS

Various embodiments of the invention are disclosed in the following detailed description and the accompanying drawings.

FIG. 1 is a schematic diagram illustrating an embodiment of a piezoresistive bridge structure usable as a strain sensor.

FIG. 2 depicts an embodiment of an integrated sensor.

FIG. 3 is a block diagram illustrating an embodiment of a system for detecting a touch inputs and utilizing touch inputs for providing user interface elements.

FIG. 4 is a diagram depicting an embodiment of a device utilizing force and touch sensors for performing touch input detection and utilizing touch inputs for providing user interface elements.

FIG. 5 is a diagram depicting an embodiment of a device utilizing force and touch sensors for performing touch input detection and utilizing touch inputs for providing user interface elements.

FIG. 6 is a diagram depicting an embodiment of a device utilizing force and touch sensors for performing touch input detection and utilizing touch inputs for providing user interface elements.

FIG. 7 is a flow chart depicting an embodiment of a method for providing user interface elements using touch inputs.

FIG. 8 is a flow chart depicting an embodiment of a method for providing user interface elements using touch inputs.

FIGS. 9A-9D are diagrams depicting an embodiment of a device utilizing touch input detection for providing user interface elements.

FIG. 10 is a flow chart depicting an embodiment of a method for updating a user interface using touch input detection.

FIGS. 11A-11B are diagrams depicting an embodiment of a device utilizing touch input detection for providing updating user interface elements.

FIGS. 12A-12B are diagrams depicting an embodiment of a device utilizing touch input detection for providing updating user interface elements.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The housing for electronic devices provides structure and protection to the components therein and typically includes openings to accommodate physical buttons used to control the device. However, such physical buttons consume valuable device spaces, provide pathways for contaminants to enter the device and have fixed locations. Consequently, other mechanisms for interfacing with an electronic device such as a mobile phone (e.g. a smartphone), a tablet, and/or a wearable is desired.

Touch surfaces are increasing utilized in displays of computer devices. Such touch surfaces can be used to interact with the device. For example, the touch surface may be part of a display for a cell phone or smart phone, a wearable, a tablet, a laptop, a television etc. Various technologies have been traditionally used to detect a touch input on such a display. For example, capacitive and resistive touch detection technology may be used. Using resistive touch technology, often a glass panel is coated with multiple conductive layers that register touches when physical pressure is applied to the layers to force the layers to make physical contact. Using capacitive touch technology, often a glass panel is coated with material that can hold an electrical charge sensitive to a human finger. By detecting the change in the electrical charge due to a touch, a touch location can be detected. However, with resistive and capacitive touch detection technologies, the glass screen is required to be coated with a material that reduces the clarity of the glass screen. Additionally, because the entire glass screen is required to be coated with a material, manufacturing and component costs can become prohibitively expensive as larger screens are desired. Capacitive touch surface technologies also may face significant issues in use with metal (i.e. conductive) and/or curved surfaces. This limitation may restrict capacitive touch surfaces to smaller, flat displays. Thus, traditional touch surfaces may be limited in utility.

Electrical components can be used to detect a physical disturbance (e.g., strain, force, pressure, vibration, etc.). Such a component may detect expansion of or pressure on a particular region on a device and provide an output signal in response. Such components may be utilized in devices to detect a touch. For example, a component mounted on a portion of the smartphone may detect an expansion or flexing of the portion to which the component is mounted and provide an output signal. The output signal from the component can be considered to indicate a purposeful touch (a touch input) of the smartphone by the user. Such electrical components may not be limited to the display of the electronic device.

However, a smartphone or other device may undergo flexing and/or localized pressure increases for reasons not related to a user's touch. Thus, purposeful touches by a user (touch inputs) are desired to be distinguished from other physical input, such as bending of the device and environmental factors that can affect the characteristics of the device, such as temperature. In some embodiments, therefore, a touch input includes touches by the user, but excludes bending and/or temperature effects. For example, a swipe or press of a particular region of a mobile phone is desired to be detected as a touch input, while a user sitting on the phone or a rapid change in temperature of the mobile phone should not to be determined to be a touch input.

A system that may provide user interface elements based on touch inputs is described. The system includes sensors and at least one processor. The sensors are configured to sense force. In some embodiments, the sensors include touch sensor(s) and/or force sensors(s). The processor receives force measurements from the sensors and identifies touch locations based on the force measurements. In some embodiments, the touch locations include a device edge (e.g. a housing) and/or a device back opposite to a display. The processor is further configured to provide at least one user interface element based on the touch locations. To provide the user interface element(s), the processor may be configured to determine a location and an orientation on a display for each of the user interface element(s). In some such embodiments, a context is also determined. For example, the context might be that the electronic device is being held in portrait or landscape mode, that the electronic device is in the user's left hand or right hand, that the user is gaming, or another context. The processor may also generate haptic feedback based on the touch locations. For example, the appropriate haptics actuators may be driven to provide a haptic response at one or more of the touch locations.

In some embodiments, a touch location corresponds to a force measurement from at least one of the sensors. The force measurement has a first magnitude. In such embodiments, the processor is further configured to update the user interface element(s) and/or generate haptic feedback based upon an additional force measurement corresponding to the touch location. The additional force measurement has a second magnitude greater than the first magnitude. In some embodiments, the second magnitude exceeds an absolute threshold and/or a relative threshold. For example, the relative threshold may be equal to the first magnitude added to a first threshold.

In some embodiments, the system also includes an orientation sensor, such as one or more accelerometers, for sensing a rotation of a display. In such embodiments, the processor may be configured to update the user interface element(s) for the rotation of a display only if the orientation sensor senses the rotation and the touch locations change.

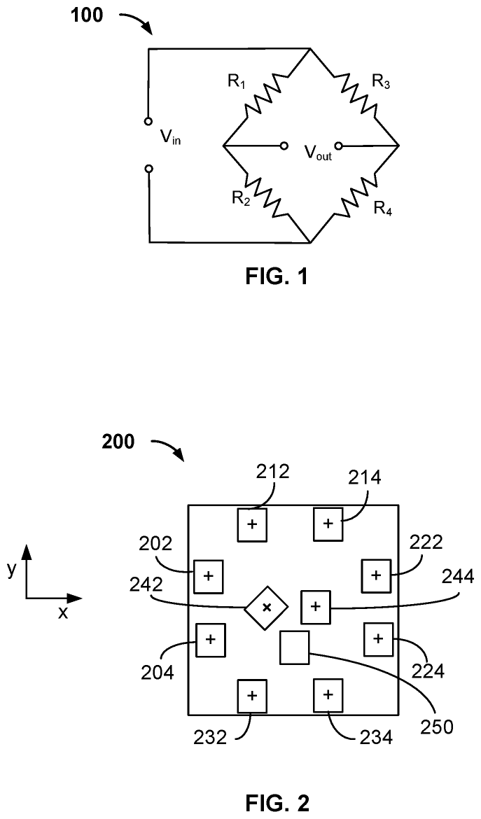

FIG. 1A is a schematic diagram illustrating an embodiment of a piezoresistive bridge structure that can be utilized as a strain sensor. Piezoresistive bridge structure 100 includes four piezoresistive elements that are connected together as two parallel paths of two piezoresistive elements in series (e.g., Wheatstone Bridge configuration). Each parallel path acts as a separate voltage divider. The same supply voltage (e.g., Vᵢₙ of FIG. 1) is applied to both of the parallel paths. By measuring a voltage difference (e.g., Vₒᵤₜ of FIG. 1) between a mid-point at one of the parallel paths (e.g., between piezoresistive elements R₁ and R₂ in series as shown in FIG. 1) and a mid-point of the other parallel path (e.g., between piezoresistive elements R₃ and R₄ in series as shown in FIG. 1), a magnitude of a physical disturbance (e.g. strain) applied on the piezoresistive structure can be detected.

In some embodiments, rather than individually attaching separate already manufactured piezoresistive elements together on to a backing material to produce the piezoresistive bridge structure, the piezoresistive bridge structure is manufactured together as a single integrated circuit component and included in an application-specific integrated circuit (ASIC) chip. For example, the four piezoresistive elements and appropriate connections between are fabricated on the same silicon wafer/substrate using a photolithography microfabrication process. In an alternative embodiment, the piezoresistive bridge structure is built using a microelectromechanical systems (MEMS) process. The piezoresistive elements may be any mobility sensitive/dependent element (e.g., as a resistor, a transistor, etc.).

FIG. 2 is a block diagram depicting an embodiment of integrated sensor 200 that can be used to sense forces (e.g. a force sensor). In particular, forces input to a device may result in flexing of, expansion of, or other physical disturbance in the device. Such physical disturbances may be sensed by force sensors. Integrated sensor 200 includes multiple strain sensors 202, 204, 212, 214, 222, 224, 232, 234, 242 and 244. Each strain sensor 202, 204, 212, 214, 222, 224, 232, 234, 242 and 244 may be a piezoresistive element such as piezoresistive element 100. In other embodiments, another strain measurement device might be used. Strain sensors 202, 204, 212, 214, 222, 224, 232, 234, 242 and 244 may be fabricated on the same substrate. Multiple integrated sensors 200 may also be fabricated on the same substrate and then singulated for use. Integrated sensor 200 may be small, for example five millimeters by five millimeters (in the x and y directions) or less.

Each strain sensor 202, 204, 212, 214, 222, 224, 232, 234, 242 and 244 is labeled with a + sign indicating the directions of strain sensed. Thus, strain sensors 202, 204, 212, 214, 222, 224, 232, 234 and 244 sense strains (expansion or contraction) in the x and y directions. However, strain sensors at the edges of integrated sensor 200 may be considered to sense strains in a single direction. This is because there is no expansion or contraction beyond the edge of integrated sensor 200. Thus, strain sensors 202 and 204 and strain sensors 222 and 224 measure strains parallel to the y-axis, while strain sensors 212 and 214 and strain sensors 232 and 234 sense strains parallel to the x-axis. Strain sensor 242 has been configured in a different direction. Strain sensor 242 measures strains in the xy direction (parallel to the lines x=y or x=−y). For example, strain sensor 242 may be used to sense twists of integrated sensor 200. In some embodiments, the output of strain sensor 242 is small or negligible in the absence of a twist to integrated sensor 200 or the surface to which integrated sensor 200 is mounted.

Thus, integrated sensor 200 obtains ten measurements of strain: four measurements of strain in the y direction from strain sensors 202, 204, 222 and 224; four measurements of strain in the x direction from sensors 212, 214, 232 and 234; one measurement of strains in the xy direction from sensors 242 and one measurement of strain from sensor 244. Although ten strain measurements are received from strain sensors 202, 204, 212, 214, 222, 224, 232, 234, 242 and 244, six measurements may be considered independent. Strain sensors 202, 204, 212, 214, 222, 224, 232, and 234 on the edges may be considered to provide four independent measurements of strain. In other embodiments, a different number of strain sensors and/or different locations for strain sensors may be used in integrated sensor 200.

Integrated sensor 200 also includes temperature sensor 250 in some embodiments. Temperature sensor 250 provide an onboard measurement of the temperatures to which strain sensors 202, 204, 212, 214, 222, 224, 232, 234, 242 and 244 are exposed. Thus, temperature sensor 200 may be used to account for drift and other temperature artifacts that may be present in strain data. Integrated sensor 200 may be used in a device for detecting touch inputs.

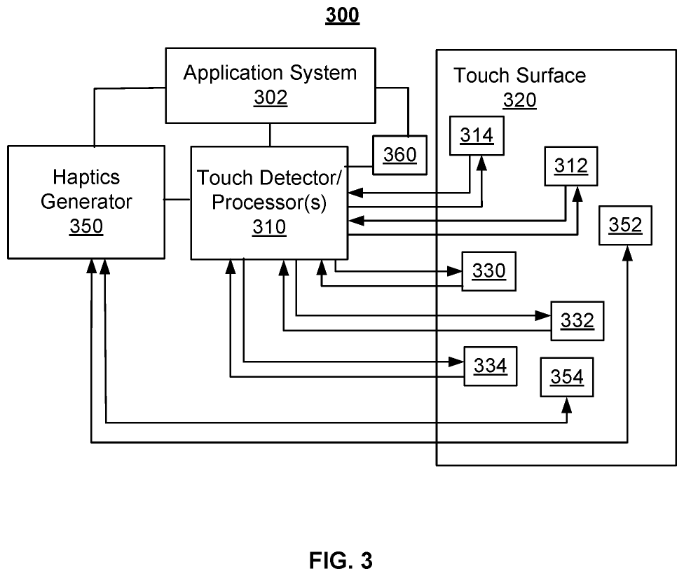

FIG. 3 is a block diagram illustrating an embodiment of system 300 for detecting and utilizing touch inputs. System 300 may be considered part of a device that can be interacted with via touch inputs. Thus, system 300 may be part of a kiosk, an ATM, a computing device, an entertainment device, a digital signage apparatus, a mobile phone (e.g. a smartphone), a tablet computer, a point of sale terminal, a food and restaurant apparatus, a gaming device, a casino game and application, a piece of furniture, a vehicle, an industrial application, a financial application, a medical device, an appliance, and any other objects or devices having surfaces for which a touch input is desired to be detected (“touch surfaces”). Furthermore, the surfaces from which a touch input may be detected are not limited displays. Instead, metal and other surfaces, such as a housing or cover, and curved surfaces, such as a device side or edge, may be used as touch surfaces.

System 300 is connected with application system 302 and touch surface 320, which may be considered part of the device with which system 300 is used. System 300 includes touch detector/processor(s) 310, force sensors 312 and 314, transmitter 330 and touch sensors 332 and 334. Also shown are optional haptics generator 350, haptics actuators 352 and 354, and additional sensor(s) 360. Although indicated as part of touch surface 320, haptics actuators 352 and 354 may be located elsewhere on the device incorporating system 300. Additional sensor(s) 360 may include orientation sensors such as accelerometer(s), gyroscope(s) and/or other sensors generally included in a device, such as a smartphone. Although shown as not located on touch surface 320, additional sensor(s) 360 may be at or near touch surface 320. Although shown as coupled with touch detector 310, in some embodiments, sensor(s) 360 and/or haptics generator 350 are simply coupled with application system 302. Haptics generator receives signals from touch detector/processor(s) 310 and/or application system 302 and drives haptics actuator(s) 352 and/or 354 to provide haptic feedback for a user. For simplicity, only some portions of system 300 are shown. For example, only two haptics actuators 352 and 354 are shown, but more may be present.

Touch surface 320 is a surface on which touch inputs are desired to be detected. For example touch surface may include the display of a mobile phone, the touch screen of a laptop, a side or an edge of a smartphone, a back of a smartphone (i.e. opposite from the display), a portion of the frame of the device or other surface. Thus, touch surface 320 is not limited to a display. Force sensors 312 and 314 may be integrated sensors including multiple strain sensors, such as integrated sensor 200. In other embodiments, force sensors 312 and 314 may be individual strain sensors. Other force sensors may also be utilized. Although two force sensors 312 and 314 are shown, another number is typically present. Touch sensors 330 and 332 may be piezoelectric sensors. Transmitter 330 may also be a piezoelectric device. In some embodiments, touch sensors 330 and 332 and transmitter 330 are interchangeable. Touch sensors 330 and 332 may be considered receivers of an ultrasonic wave transmitted by transmitter 330. In other cases, touch sensor 332 may function as a transmitter, while transmitter 330 and touch sensor 334 function as receivers. Thus, a transmitter-receiver pair may be viewed as a touch sensor in some embodiments. Multiple receivers share a transmitter in some embodiments. Although only one transmitter 330 is shown for simplicity, multiple transmitters may be used. Similarly, although two touch sensors 332 and 334 are shown, another number may be used. Application system 302 may include the operating system for the device in which system 300 is used.

In some embodiments, touch detector/processor(s) 310 is integrated in an integrated circuit chip. Touch detector 310 includes one or more microprocessors that process instructions and/or calculations that can be used to program software/firmware and/or process data for touch detector 310. In some embodiments, touch detector 310 include a memory coupled to the microprocessor and configured to provide the microprocessor with instructions. Other components such as digital signal processors may also be used.

Touch detector 310 receives input from force sensors 312 and 314, touch sensors 332 and 334 and, in some embodiments, transmitter 330. For example, touch detector 310 receives force (e.g. strain) measurements from force sensors 312 and 314, touch (e.g. piezoelectric voltage) measurements from touch sensors 332 and 334. Although termed “touch” measurements, such measurements may also be considered a measure of force. Touch detector 310 may also receive temperature measurements from onboard temperature sensors for force sensors 312 and/or 314, such as temperature sensor 250. Touch detector may also obtain temperature data from one or more separate, dedicated temperature sensor(s). Touch detector 310 may provide signals and/or power to force sensors 312 and 314, touch sensors 332 and 334 and transmitter 330. For example, touch detector 310 may provide the input voltage(s) to force sensors 312 and 314, voltage or current to touch sensor(s) 332 and 334 and a signal to transmitter 330. Touch detector 310 utilizes the force (strain) measurements and/or touch (piezoelectric) measurements to determine whether a user has provided touch input touch surface 320. If a touch input is detected, touch detector 310 provides this information to application system 302 and/or haptics generator 350 for use.

Signals provided from force sensors 312 and 314 are received by touch detector 310 and may be conditioned for further processing. For example, touch detector 310 receives the strain measurements output by force sensors 312 and 314 and may utilize the signals to track the baseline signals (e.g. voltage, strain, or force) for force sensors 312 and 314. Strains due to temperature may also be accounted for by touch detector 310 using signals from a temperature sensor, such as temperature sensor 250. Thus, touch detector 310 may obtain absolute forces (the actual force on touch surface 320) from force sensors 312 and 314 by accounting for temperature. In some embodiments, a model of strain versus temperature for force sensors 312 and 314 is used. In some embodiments, a model of voltage or absolute force versus temperature may be utilized to correct force measurements from force sensors 312 and 314 for temperature.

In some embodiments, touch sensors 332 and 334 sense touch via a wave propagated through touch surface 320, such as an ultrasonic wave. For example, transmitter 330 outputs such an ultrasonic wave. Touch sensors 332 and 334 function as receivers of the ultrasonic wave. In the case of a touch by a user, the ultrasonic wave is attenuated by the presence of the user's finger (or other portion of the user contacting touch surface 320). This attenuation is sensed by one or more of touch sensors 332 and 334, which provide the signal to touch detector 310. The attenuated signal can be compared to a reference signal. A sufficient difference between the attenuated signal and the reference signal results in a touch being detected. The attenuated signal corresponds to a force measurement. Because the attenuation may also depend upon other factors, such as whether the user's is wearing a glove, such force measurements from touch sensors may be termed imputed force measurements. In some embodiments, absolute forces may be obtained from the imputed force measurements. As used herein in the context of touch sensors, imputed force and force may be used interchangeably.

Encoded signals may be used in system 300. In some embodiments, transmitter 330 provides an encoded signal. For example, transmitter 330 may use a first pseudo-random binary sequence (PRBS) to transmit a signal. If multiple transmitters are used, the encoded signals may differ to be able to discriminate between signals. For example, the first transmitter may use a first PRBS and the second transmitter may use a second, different PRBS which creates orthogonality between the transmitters and/or transmitted signals. Such orthogonality permits a processor or sensor coupled to the receiver to filter for or otherwise isolate a desired signal from a desired transmitter. In some embodiments, the different transmitters use time-shifted versions of the same PRBS. In some embodiments, the transmitters use orthogonal codes to create orthogonality between the transmitted signals (e.g., in addition to or as an alternative to creating orthogonality using a PRBS). In various embodiments, any appropriate technique to create orthogonality may be used. In some embodiments, encoded signals may also be used for force sensors 312 and 314. For example, an input voltage for the force sensors 312 and 314 may be provided. Such an input signal may be encoded using PRBS or another mechanism.

In some embodiments, only force sensors 312 and 314 may be used to detect touch inputs. In some such embodiments, drifts and other temperature effects may be accounted for using temperature sensor 250. Bending or other flexing may be accounted for using strain sensor 242. In other embodiments, only touch sensors 332 and 334 may be used to detect touch inputs. In such embodiments, touch inputs are detected based upon an attenuation in a signal from transmitter 330. However, in other embodiments, a combination of force sensors 312 and 314 and touch sensors 332 and 334 are used to detect touch inputs.

Based upon which sensor(s) 312, 314, 332 and/or 334 detects the touch and/or characteristics of the measurement (e.g. the magnitude of the force detected), the location of the touch input in addition to the presence of a touch input may be identified. For example, given an array of force and/or touch sensors, a location of a touch input may be triangulated based on the detected force and/or imputed force measurement magnitudes and the relative locations of the sensors that detected the various magnitudes (e.g., using a matched filter). Further, data from force sensors 312 and 314 can be utilized in combination with data from touch sensors 332 and 334 to detect touches. Utilization of a combination of force and touch sensors allows for the detection of touch inputs while accounting for variations in temperature, bending, user conditions (e.g. the presence of a glove) and/or other factors. Thus, detection of touches using system 300 may be improved.

For example, touch detector 310 receives force measurements from force sensors 312 and 314. Touch detector 310 receives imputed force measurements from touch sensors 332 and 334. Touch detector 310 identifies touch inputs based upon at least the imputed force measurements. In such embodiments, force measurements are utilized to calibrate one or more touch input criterion for touch sensors 332 and 223. For example, if a user is wearing a glove, the attenuation in the ultrasonic signal(s) sensed by touch sensors 332 and 334 may be reduced. Consequently, the corresponding imputed force measurements may not result in a detection of a touch input. However, force measurements from force sensors 312 and/or 314 correlated with and corresponding to the touch input of a user wearing a glove indicate a larger force than the imputed force measurements. In some embodiments, the measured forces corresponding to the output of touch sensors 332 and 334 are recalibrated (e.g. raised in this example) so that a reduced attenuation in the ultrasonic signal(s) is identified as a touch input. In some embodiments, a touch input is detected if the force meets or exceeds a threshold. Thus, the threshold for detecting a touch input using the signals from touch sensors 332 and 334 is recalibrated (e.g. decreased in this example) so that a reduced attenuation in the ultrasonic signal(s) is identified as a touch input. Thus, the user's condition can be accounted for. Further, touch sensors 312 and 334 may be piezoelectric sensors and thus insensitive to bends and temperature. Consequently, such effects may not adversely affect identification of touch inputs. In embodiments in which both force and imputed force measurements are used in identifying a touch input, only if force measurements from force sensors (e.g. strains indicating an input force at a particular time and location) and imputed force measurements (e.g. piezoelectric signals indicating an input force at a corresponding time and location) are sufficiently correlated. In such embodiments, there may be a reduced likelihood of bends or temperature effects resulting in a touch input being detected. The touch input criterion/criteria may then be calibrated as described above.

Thus, using system 300, touch inputs may be detected. If both force and imputed force measurements (e.g. strain and piezoelectric measurements), issues such as changes in temperature and bending of the touch surface may not adversely affect identification of touch inputs. Similarly, changes in the user, such as the user wearing a glove, may also be accounted for in detecting touch inputs. Further, the dynamic ranges of force sensors and touch sensors may differ. In some embodiments, piezoelectric touch sensors may be capable of sensing lighter touches than strain gauges used in force sensors. A wider variety of touch inputs may, therefore, be detected. Moreover, force and/or touch sensors may be utilized to detect touch inputs in regions that are not part of a display. For example, the sides, frame, back cover or other portions of a device may be used to detect touch inputs. Consequently, detection of touch inputs may be improved.

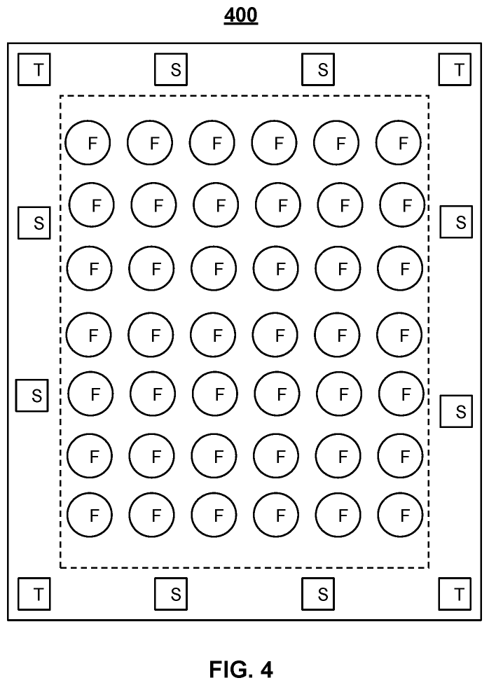

FIGS. 4-6 depict different embodiments of systems 400, 500, and 600 utilizing force and touch sensors for touch input detection. Force sensors, such as sensor(s) 100, 200, 312 and/or 314, are denoted by an “F”. Such force sensors are shown as circles and may be considered to be piezoresistive (e.g. strain) sensors. Such force sensors may also be considered integrated sensors that provide multiple strain measurements in various directions as well as temperature measurements. Touch sensors such as sensor(s) 332 and/or 334 are shown by an “S”. Transmitters, such as transmitter 330, are shown by a “T”. Such sensors and transmitters may be piezoelectric sensors and are shown as rectangles. As indicated above, sensor component arrangements are utilized to detect a touch input along a touch surface area (e.g., to detect touch input on a touchscreen display; a side, back or edge of a smart phone; a frame of a device, a portion of a mobile phone, or other region of a device desired to be sensitive to touch). The number and arrangement of force sensors, transmitters, and touch sensors shown in FIGS. 4-6 are merely examples and any number, any type and/or any arrangement of transmitters, force sensors and touch sensors may exist in various embodiments.

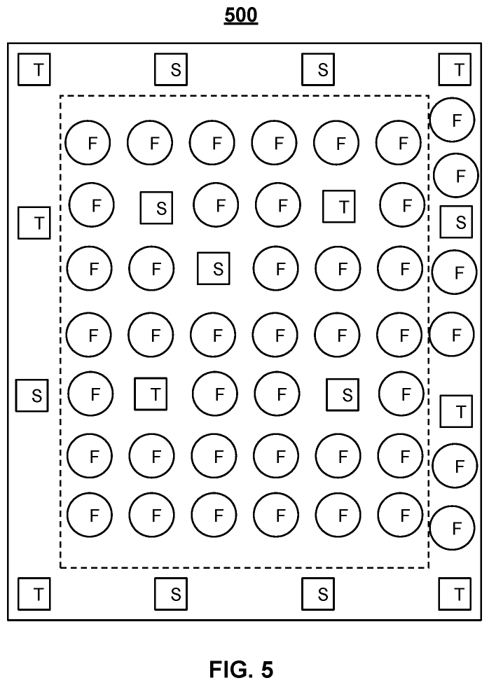

For example, in the embodiment shown in FIG. 4, device 400 includes touch sensors near the edges (e.g. along the frame) and force sensors closer to the central portion of device 400. For example, force sensors might be used along the back cover or for the display. FIG. 5 depicts another arrangement of force sensors, touch sensors and transmitters on device 500. In this embodiment, force sensors and touch sensors are used not only near the edges (e.g. on a housing), but also for a central portion, such as a display. Thus, virtually all of device 500 may be used as a touch surface.

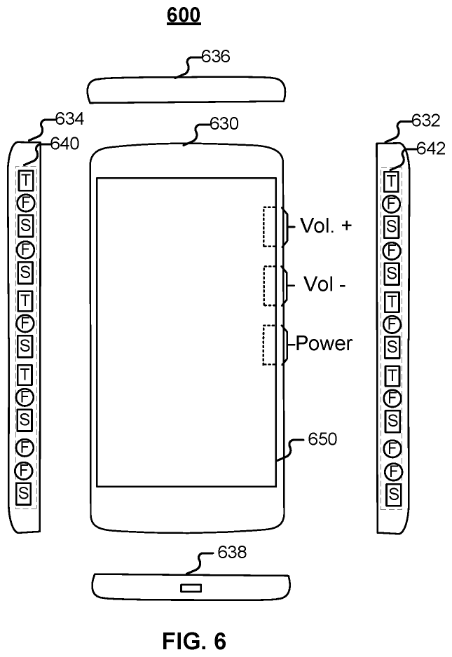

FIG. 6 is a diagram illustrating different views of device 600, a smart phone, with touch input enabled housing. Front view 630 of the device shows a front display surface of the device. Left side view 634 of the device shows an example touch surface 640 on a sidewall of the device where a touch input is able to be detected. Both touch sensors and force sensors are used to detect touches of touch surface 640. For example, a location and a force of a user touch input are able to be detected in region 640 by detecting disturbances to transmitted signals in region 640. By touch enabling the side of the device, one or more functions traditionally served by physical buttons are able to be provided without the use of physical buttons. For example, volume control inputs are able to be detected on the side without the use of physical volume control buttons. Right side view 632 of the device shows touch input external surface region 642 on another sidewall of the device where a user touch input can be detected. Although regions 640 and 642 have been shown as smooth regions, in various other embodiments one or more physical buttons, ports, and/or openings (e.g., SIM/memory card tray) may exist, or the region can be textured to provide an indication of the sensing region. Touch input detection may be provided over surfaces of physical buttons, trays, flaps, switches, etc. by detecting transmitted signal disturbances to allow touch input detection without requiring detection of physical movement/deflection of a component of the device (e.g., detect finger swiping over a surface of a physical button). In some embodiments, the touch input regions on the sides may be divided into different regions that correspond to different functions. For example, virtual volume and power buttons have been defined on right side 632. The touch input provided in region 640 (and likewise in region 642) is detected along a one-dimensional axis. For example, a touch location is detected as a position on its lengthwise axis without differentiating the width of the object touching the sensing region. In an alternative embodiment, the width of the object touching the sensing region is also detected. Regions 640 and 642 correspond to regions beneath which touch input transmitters and sensors are located. A particular configuration of force sensors (F), touch sensors (S) and transmitters (T) is shown for simplicity. Other configurations and/or other sensors may be used. Although two touch input regions on the housing of the device have been shown in FIG., other touch input regions on the housing may exist in various other embodiments. For example, surfaces on top (e.g., surface on top view 636) and/or bottom (e.g., surface on bottom view 638) of the device are touch input enabled. The shapes of touch input surfaces/regions on device sidewalls (e.g., regions 640 and 642) may be at least in part flat, at least in part curved, at least in part angular, at least in part textured, and/or any combination thereof. Further, display 650 is also a touch surface in some embodiments. For simplicity, sensors are not shown in display 650. Sensors analogous to those described herein and/or other touch sensors may be used in display 650.

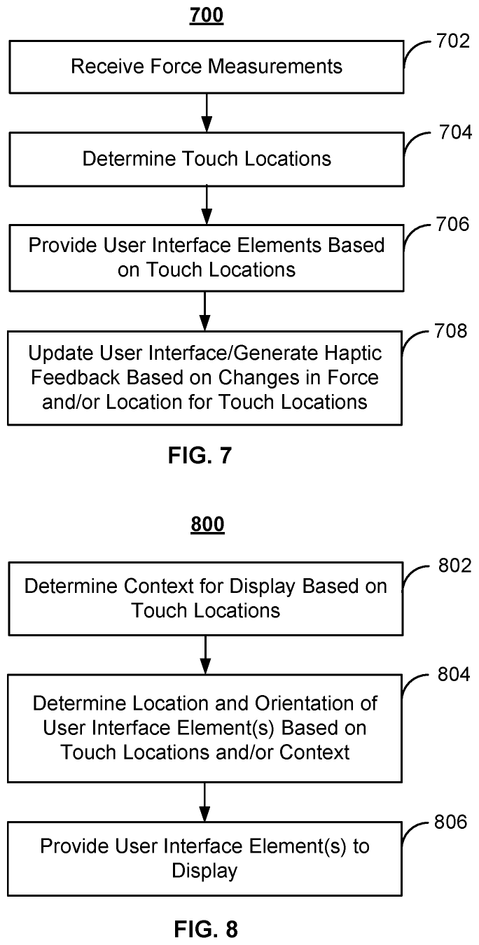

Utilizing force measurements from force and/or touch sensors, a user interface may be better controlled. FIG. 7 is a flow chart depicting an embodiment of method 700 for detecting touch inputs using touch and/or force sensors and for providing user interface elements using the touch inputs. In some embodiments, processes of method 700 may be performed in a different order, including in parallel, may be omitted and/or may include substeps.

Force measurements are received from force sensors, at 702. Force sensors, such as strain sensors and/or touch sensors, provide an output signal that is received at 702. In some embodiments, the signal corresponding to the force measurements provided is a voltage signal that may be conditioned, converted to a digital signal for processing, or otherwise processed. In some embodiments, 702 includes transmitting ultrasonic signal(s), receiving the ultrasonic signal(s) at touch sensors, and the touch sensors providing the received ultrasonic signal for further processing. The ultrasonic signal(s) provided may be encoded. The received signals output by the touch sensors and corresponding to the imputed force measurements may also be encoded.

Touch locations are identified, at 704. Identification of touch locations includes detecting touch inputs, for example as described above. Thus, in some embodiments, a touch may be detected if a measured force exceeds a particular threshold. In addition, the locations of the touch inputs based are determined upon the characteristics of the force measurements and the location(s) of the corresponding sensors. Thus, at 702 and 704, the magnitude of the force and the location of the force due to the user's touch input can be determined.

User interface elements are provided based on the touch locations, at 706. User interface elements may include elements such as virtual buttons (e.g. volume increase, volume decrease, power, menu buttons), slide bars (e.g. for controlling magnification of images presented on a display), menus (e.g. menu bars, the direction a menu drops down), information (e.g. a battery power bar), icons and/or other elements that allow a user to provide input to and receive output from the device. Although the user interface elements are presented to the user on the display, at least some user interface elements may correspond to portions of the device distinct from the display. For example, virtual buttons may be depicted on the display but may be activated by user touches at the sides of the device as depicted in FIG. 6. To provide the user interface elements, the location and number of touch inputs may be utilized to determine where and in what orientation to display the user interface elements. The user interface elements are also presented to the user as part of 706.

At 708, user interface elements may be updated based upon changes in the force and/or touch locations. Also at 708, haptic feedback may be generated also based upon changes in the force applied by the user and/or changes in the touch locations. For example, a sufficient increase or decrease in the force may be used to update the user interface and/or generate haptic feedback. In some embodiments, if the force applied to a touch location exceeds a threshold larger than the touch threshold used in determining the touch location, a user is considered to have pressed a (virtual) button at the touch location or squeezed the frame to activate a function. For example, a force having a magnitude that meets or, in some embodiments exceeds, a first level results in a touch being detected and a touch location identified at 704. A force having a magnitude that meets or, in some embodiments exceeds, a second level greater than the first level results in the detection of a button push or other selection at 708. In some embodiments, the thresholds are absolute. For example, the second level may be a particular force determined by the manufacturer or based upon prior training by the user. In some embodiments, the thresholds may be relative. For example, the second level may exceed the first level by a fraction multiplied by the actual force the user applied for touch detection. In another example, the second level may exceed the first level by a fraction multiplied by the first level. In some cases, the user may move their finger, for example to activate a slide bar. In such instances, the change in the touch location (e.g. the removal of one location and the addition of a new touch location) may result in an update. In some embodiments, changes in force and/or touch location may also trigger the generation of haptic feedback. In the examples above, a button press or touch location change may result in actuators being activated to provide vibrations (e.g. at the new touch location or by the device generally) or simulate the click of a button. Thus, feedback and/or updates to the user interface may be provided.

For example, force measurements may be received by touch input detect/processor(s) at 702. These force measurements are received from force sensors 312 and 314 and/or touch sensors 332 and/or 334. Thus, the force measurements may include imputed force measurements. However, as discussed above, in some embodiments, absolute forces may be determined from imputed force measurements. Further, temperature, bending of the device and other artifacts may be accounted for. Touch detector/processor(s) 310 determines the touch locations for the touch inputs detected, at 704. Based on the touch locations and, in some embodiments, the force measurements, touch detector/processor(s) 310 provide user interface elements. For example, the location and orientation the virtual power and volume buttons depicted as dotted lines in FIG. 6 may be determined by touch detector/processor(s) 310 and provided to display 650.

AT 708, force sensor 312 and/or touch sensor 332 may sense an increase in force. This may occur without the user removing their finger from the corresponding device. In the example above, the user may have a finger already located at the volume increase button and may depress the side of device 600. If a force that meets or exceeds the second level is sensed, then at 708 the volume is increased. Further, a volume indicator (not shown in FIG. 6) may be updated. In some embodiments, this increase in force may also be used to generate haptic feedback at 708. For example, a click mimicking a button push may be provided to the location of the user's finger (e.g. the touch location). In another example, the user may remove their fingers from the region of the virtual volume buttons shown in FIG. 6. A change in touch location is detected at 708. In response, the user interface may be updated to remove the volume controls from the right side of device 600.

Thus, using method 700 user interface elements may be provided and updated based upon the forces sensed and touch locations. Consequently, physical buttons may be replaced by or complemented with virtual buttons. As a result, the corresponding device may be less subject to contaminants entering through physical buttons. Further, on such touch surfaces such as the sides of the device, higher resolution interactivity may be provided. User interface elements may also be generated and updated based upon touches to part of the device other than the display. This may increase the fraction of the display usable for viewing and improve ease of use of the device.

FIG. 8 is a flow chart depicting an embodiment of method 800 for providing user interface elements using touch inputs. In some embodiments, processes of method 800 may be performed in a different order, including in parallel, may be omitted and/or may include substeps. In some embodiments, method 800 may be used in performing 706 and/or 708 of method 700.

The context for a device is determined based on the touch locations, at 802. The context is so termed because the context is determined while the user utilizes the device, typically without requiring active input by the user specifically to identify the context. For example, the context might be that the electronic device is being held in portrait or landscape orientation, that the electronic device is in the user's left hand or right hand, that the user is gaming, that the user is taking a photograph and/or another context.

Features of the touch locations identified at 706 may be used in determining the context. For example, if the one touch location is on one side of the device and four touch locations are on an opposing side, the device may be considered to be in portrait mode. In some embodiments, the size of the touch location and the forces applied at the touch locations may also be used in determining context. For example, a larger, single touch location at which a larger force is applied to a side of the frame of a device may correspond to a thumb, while a very large touch location on the back cover of the device may correspond to a palm. Smaller touch locations on the opposing side of the device may correspond to fingers. Thus, whether the user holds the device in the left or right hand may also be determined. External inputs may also be used in determining context at 802. For contexts such as gaming, the touch locations may be used in conjunction with the application running on the device in order to determine context. In some embodiments, additional inputs such as from sensors including orientation sensors such as accelerometers and/or gyroscopes may be used to determine context. For example, whether a smartphone is in portrait or landscape mode with respect to the earth's surface/gravity may be determined via accelerometer and/or gyroscope input.

The locations, orientations, and/or other characteristics of user interface elements are determined based on the touch locations and context, at 804. For example, buttons may be located in proximity to touch locations for ease of access, while menu bars may be located distal from touch locations to improve visibility. The orientation of buttons, menus, slide bars and/or other user interface elements may be determined at 804. For example, menus are oriented so that a user may be better able to read the information on the menu. Slide bars may be oriented such that the direction a user slides the bar is easier to reach. Using the locations, orientations and/or other characteristics determined at 804, the user interface elements are rendered on the display at 806.

Thus, using method 800 user interface elements may be provided and updated based upon the context as determined by the forces sensed and touch locations. Consequently, physical buttons may be removed. As a result, the corresponding device may be less subject to contaminants entering through physical buttons. The configuration of the user interface may also be more readily customizable. User interface elements may also be generated and updated based upon touches to part of the device other than the display. This may enhance usability of the device.

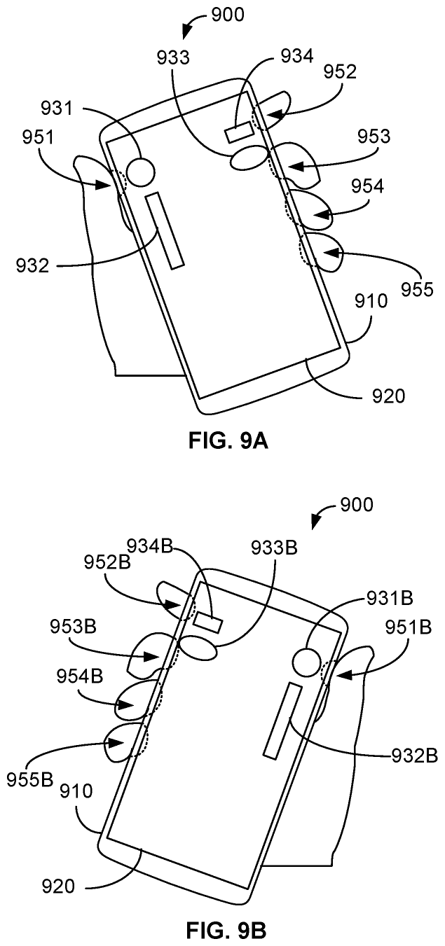

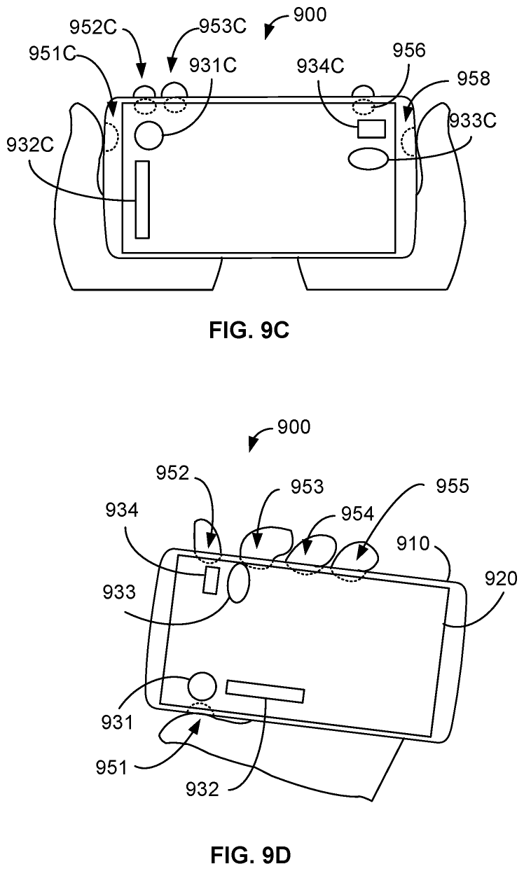

In some embodiments, touch detector/processor(s) 310 may determine the context at 802 and configure the user interface elements at 804. These user interface elements may be provided to the display at 806. For example, FIGS. 9A-9D depict device 900 for various contexts. Device 900 includes housing 910 and display 920. In FIG. 9A, the user is holding device 900 in their left hand. Thus, touch locations 951, 952, 953, 954 and 955 (shown as dashed lines) on the sides of housing 910 have been identified at 704. Based on the touch locations 951, 952, 953, 954 and 955, the context for device 900 has been determined as portrait and being held in the user's left hand. This is based at least in part on one touch location 951 being on one side of device 900, while touch locations 952, 953, 954 and 955 are on the opposing side of device 900. In some embodiments, the forces corresponding to and/or sizes of touch locations 951, 952, 953, 954 and/or 955 may be used in determining this context.

User interface elements 931, 932, 933 and 934 (collectively user interface elements 930) have been provided based the context. User interface elements 931 and 933 may be virtual buttons, user interface element 932 may be a slide bar or jog wheel, user interface element 934 may be a portion of a menu or a text item. For example, the location and orientation of slide bar/jog wheel 932 has been selected for ease of access by the user's thumb corresponding to touch location 951. Similarly, button 933 has been placed for ease of access by the user's finger(s) corresponding to touch location(s) 952 and/or 953. In some embodiments, a visual guide may be provided to indicate to the user the location(s) of the software-defined jog wheel or other user interface elements 931, 392, 933 and 934. For example, a symbol identifying the buttons and/or a light may be used to indicate the software-defined button. A user may use a single hand to select operate the slide bar/jog wheel 932 or other buttons, for example scrolling through web pages or apps depicted on the display of mobile device 400. Thus, the user interface elements 9310 may not only be located but also controlled via the user's touch.

FIG. 9B depicts a different context. The user now holds device 900 in their right hand. Thus, touch locations 951B, 952B, 953B, 954B and 955B (shown as dashed lines) on the sides of housing 910 have been identified at 704. Based on the touch locations 951B, 952B, 953B, 954B and 955B, the context for device 900 has been determined as portrait and being held in the user's right hand. This is based at least in part on one touch location 951B being on one side of device 900, while touch locations 952B, 953B, 954B and 955B are on the opposing side of device 900. In some embodiments, the forces corresponding to and/or sizes of touch locations 951B, 952B, 953B, 954B and/or 955B may be used in determining this context.

User interface elements 931B, 932B, 933B and 934B have been provided based the context. Thus, the locations of user interface elements 931B, 932B, 933B and 934B have been switched from that shown in FIG. 9A. However, because device is still in portrait orientation, the orientations of user interface elements 931B, 932B, 933B and 934B have not changed.

FIG. 9C depicts a different context. The user now holds device 900 in both hands. Thus, touch locations 951C, 952C, 953C, 956 and 958 (shown as dashed lines) on the top, bottom and sides of housing 910 have been identified at 704. Based on the touch locations 951C, 952C, 953C, 956 and 958, the context for device 900 has been determined as landscape and being held in both hands. This is based at least in part touch locations 951C and 958 being on opposite ends of device 900, while touch locations 951C, 952C, 953C and 955 are on one side of device 900. In some embodiments, the clustering of touch locations 951C, 952C, 953C, 956 and 958 by the corners of device 900 and/or touch locations (not shown) being identified on the back of device 900 may also be used in determining context. In some embodiments, the forces corresponding to and/or sizes of touch locations 951C, 952C, 953C, 956 and/or 958 may be used in determining this context.

User interface elements 931C, 932C, 933C and 934C have been provided based the context. Thus, both the locations and the orientations (with respect to display 920) of user interface elements 931C, 932C, 933C and 934C have been switched from that shown in FIG. 9A. However, because device is still in portrait orientation, the orientations of user interface elements 931B, 932B, 933B and 934B have not changes.

FIG. 9D depicts another situation. The user again holds device 900 in their left hand. In the situation shown, the touch locations 951. 952. 953. 954 and 955 and user interface elements 931, 932, 933 and 934 are the same as in FIG. 9A. However, the orientation of the user's hand, as well as device 900, has changed. This may occur, for example, when the user is lying down.

As discussed with respect to FIG. 9A, the context is determined to be portrait and held in the left hand. Consequently, the locations and orientations of display elements, 931, 932, 933 and 934 in FIG. 9D are the same as in FIG. 9A. This is in contrast to the behavior of a conventional device, for which the display would automatically rotate to be analogous to the orientation depicted in FIG. 9C due to input from an orientation sensor. However, because of the manner in which the user is holding device 900 as indicated by touch locations 951, 952, 953, 954 and 955, the location and orientation of user interface elements 931, 932, 933 and 934 remains unchanged. Stated differently, device 900 may update the user interface element(s) 931, 932, 933 and 934 for the rotation of display 920 only if the orientation sensor senses the rotation and the touch locations are consistent with a landscape orientation. For example, if touch locations changed to those shown in FIG. 9C, the orientation and locations of user interface elements 931, 932, 933 and 934 may be updated.

Thus, user interface elements may be provided and updated based upon the context as indicated by touch locations and/or forces. Consequently, the ease of operation, flexibility, reliability (e.g. being water tight) of device 900 using the method 700 and/or 800 may be improved.

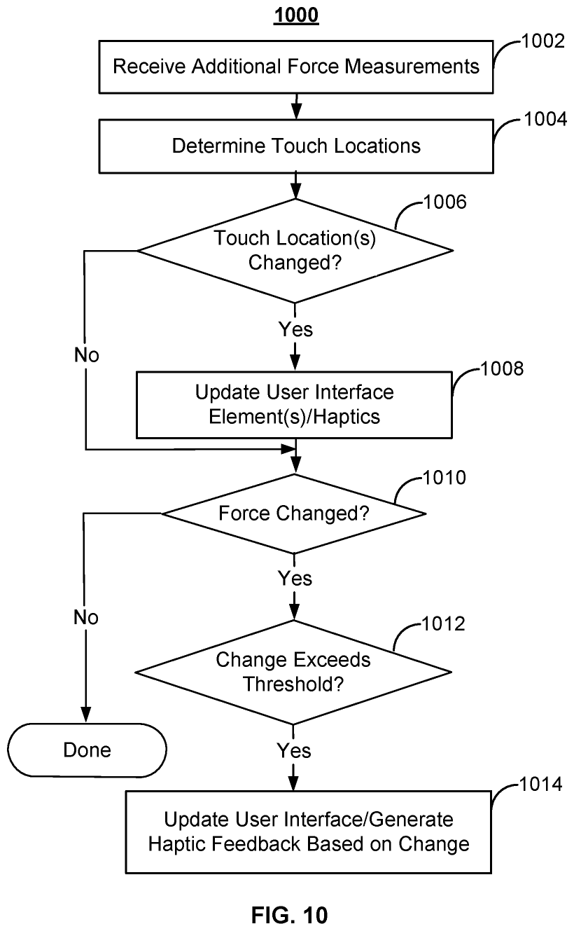

FIG. 10 is a flow chart depicting an embodiment of method 1000 for updating user interface elements using touch inputs. In some embodiments, processes of method 1000 may be performed in a different order, including in parallel, may be omitted and/or may include substeps. In some embodiments, method 1000 may be used in performing 706 and/or 708 of method 700.

Additional force measurements are received from force sensors, at 1002. Thus, 1002 is analogous to 702 of method 700. Touch locations are identified, at 1004. In some embodiment, 1004 is analogous to 704 of method 700. At 1006 it is determined whether the touch locations have changed. For example, touch locations 951B, 952B, 953B, 954B and 955B may be compared to touch location 951, 952, 953, 954 and 955. If the touch locations have not changed, then method 1000 continues. If however, the touch locations have changed, then the user interface elements may be updated and/or haptic feedback generated, at 1008. To generate haptic feedback, a signal may be provided from touch detector/processor(s) 310 to haptics generator 350. Alternatively, a signal may be provided from touch detector/processor(s) 310 to application system 302. In response, application system 302 provides a signal to haptics generator 30. Haptics generator 350 provides the appropriate signal(s) to one or more haptics actuator(s) 352 and/or 354 to provide the haptic feedback at the desired location(s).

It is determined whether the force(s) have changed, at 1010. If not, then method 1000 is completed. If the force(s) measured by force and/or touch sensors have changed, then it is determined whether the change(s) exceed the appropriate thresholds. An increase in the force, particularly followed by a decrease in force, may indicate a virtual button push. A decrease in force may indication a movement by the user's finger(s) or other action. In response to the change in force(s) the user interface elements may be updated and/or haptic feedback generated.

Thus, using method 1000 a user is able to control the user interface and receive feedback without requiring that that the user lifts their finger from the display. Instead, a change in force is sufficient for at least some updates. This may facilitate use of the corresponding device.

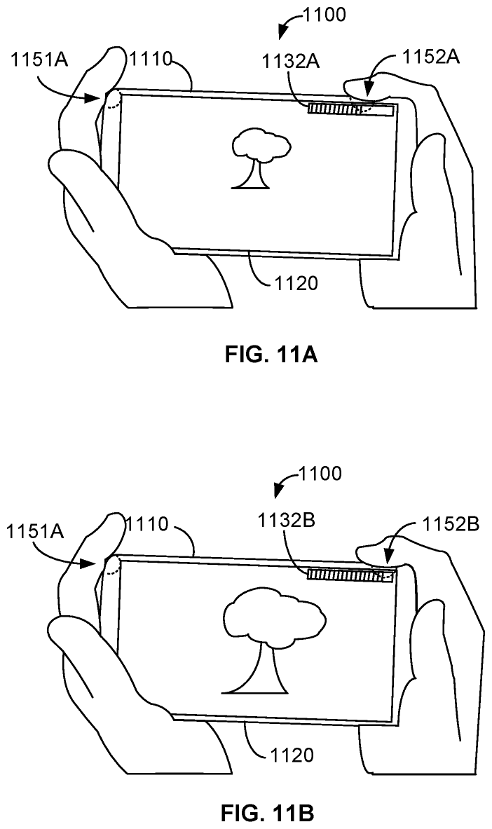

For example, FIGS. 11A and 11B depict an embodiment of device 1100 utilizing touch input detection for providing updating user interface elements. Device 1100 includes housing 1110 and display 1120. In FIG. 11A, the user is holding device 1100 in both hands in a portrait orientation. Thus, touch locations 1151A and 1152A (shown as dashed lines) on the sides/corner of housing 1110 have been identified. Also shown is user interface element 1132A, a slide bar, that has been generated using techniques described herein. Slide bar 1132A may be used to adjust the zoom. Although depicted in FIG. 11 as along the upper right hand corner of mobile device 1100, slide bar 1132A may be located elsewhere on display 1120 or other portion of mobile device 1100 because slide bar 1110 is software-defined. For example, because touch sensors may be on the edges, back side and across the display, slide bar 1110 might be located at any of these regions. In some embodiments, other controls may also be provided via software and touch sensing. In some embodiments, a two position shutter may be provided. In such an embodiment, a light press to the software-defined shutter focuses the camera, while a full/higher force press captures the image. In some embodiments, a slide may also be provided to adjust the F-number of the camera of mobile device 1100. Thus, a user may touch the mobile device and slide their finger to adjust the aperture settings. In some embodiments, the software-defined slide may be configured to mimic conventional, professional systems. Finer controls that may be possible via such software-defined buttons may reduce the camera shake, improve response time of the camera and enhance the user's ability to capture images.

FIG. 11B depicts device 1100 after the user has slid their finger along the edge of device 1100. Thus, touch location 1152B has changed location. In some embodiments, the change in location may be identified simply by the user removing their finger and replacing their finger at a different location. In some embodiments, the user's finger remains in contact with device 1100 while adjusting slide bar 1132B. Thus, at 1006 of method 1000, it can be determined that touch location 1132A has changed to 1132B. In response, the user interface elements are updated at 1008. The amount of zoom (cross hatching) on slide bar 1132A has been adjusted to be shown in 1132B. Further, the image depicted on display 1120 has been updated to be zoomed.

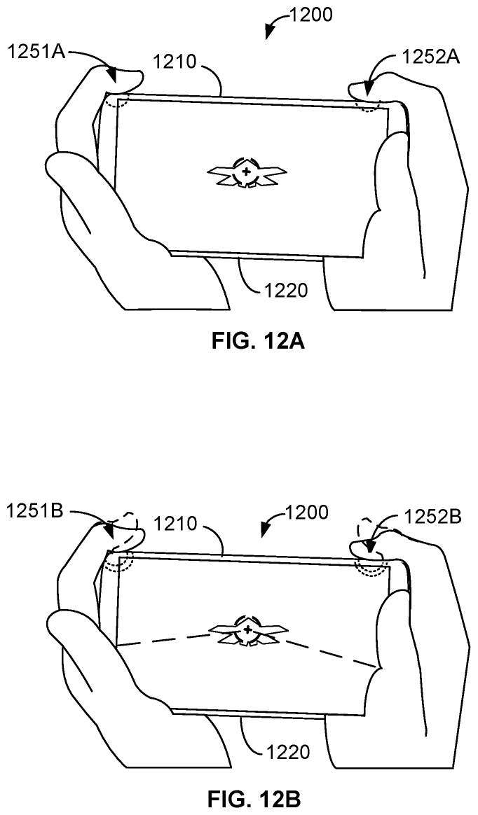

Similarly, FIGS. 12A and 12B depict an embodiment of device 1200 utilizing touch input detection for providing updating user interface elements during gaming. Device 1200 includes housing 1210 and display 1220. In FIG. 12A, the user is holding device 1200 in both hands in a portrait orientation. Thus, touch locations 1251A and 1252A (shown as dashed lines) on the sides/corner of housing 1210 have been identified. In the embodiment shown, a user is playing a game on device 1200. Using method 1000, the game may be played, and user interface elements updated, using touch inputs. For example, a user may fire by touching the edges of mobile device 1200 instead of the screen.

In the embodiment shown in FIG. 12B, the user's index fingers are activating the fire buttons along the top edges of mobile device 1200. In some embodiments, the user may lift their fingers, then replace them on the top edge to fire. This action is shown by dashed lines in FIG. 12B. Such an action may be viewed as a change in touch location, allowing the user interface to be updated at 1008 of method 1000. In some embodiments, the user may simply depress the frame, resulting in a change (e.g. an increase) in force. This is indicated by the multiple dashed lines for each touch location 1251B and 1252B. Consequently, the user's fingers need not lose contact with device 1200 to play the game. Further, because the edges of device 1200 are used, the user's fingers may not block the display during game play. Stated differently, a resting finger that is desired not to trigger firing need not be lifted off of the software-defined buttons. Instead, the software-defined buttons may be configured such that a light touch (resting finger/lower force threshold) does not activate the button, while a firmer touch (more force applied to the location of the software-defined button/higher force threshold met/exceeded) does. Such a change in force may be determined at 1010 and 1012. Thus user interface may be updated at 1014. Thus, dashed lines in display 1220 indicated that the user has fired on the target.

In addition, haptics may be incorporated to mimic the response of a physical button and/or provide other feedback, at 1014. For example, at 1014, the touch sensing system of mobile device 1200 may provide a signal for an actuator or other motion generator that can vibrate or otherwise cause motions in some or all of mobile device 1200. Thus, using such a haptic system, software-defined buttons function and feel similar to a physical button. In some embodiments, mobile device 1200 may be configured such that the point of view may be changed via a software-defined slide (not shown). Such a slide may be analogous to slide bar 932. Thus, such a slide may be provided on the display, edge, or back of mobile device 1200. In some embodiments, the locations and operation of the controls may be customized by the user. Thus, mobile device 1200 may provide rapid response as well as an intuitive, customizable, and rapid.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a plurality of sensors configured to sense force; and
a processor configured to:
receive a plurality of force measurements from the plurality of sensors;
identify a plurality of touch locations based on the plurality of force measurements; and
provide at least one user interface element based on the plurality of touch locations.

2. The system of claim 1, wherein the plurality of touch locations include at least one of a device edge and a device back opposite to a display.

3. The system of claim 1, wherein to provide the at least one user interface element, the processor is further configured to:
determine a location and an orientation on a display for each of the at least one user interface element.

4. The system of claim 1, wherein the processor is further configured to:
generate haptic feedback based on the plurality of touch locations.

5. The system of claim 1, wherein a touch location of the plurality of touch locations corresponds to a force measurement from at least one sensor of the plurality of sensors, the force measurement having a first magnitude and wherein the processor is further configured to:
update the at least one user interface element based upon an additional force measurement corresponding to the touch location, the additional force measurement having a second magnitude greater than the first magnitude.

6. The system of claim 5, wherein the second magnitude exceeds at least one of an absolute threshold and a relative threshold equal to the first magnitude added to a first threshold.

7. The system of claim 1, wherein a touch location of the plurality of touch locations corresponds to a force measurement from at least one sensor of the plurality of sensors, the force measurement having a first magnitude and wherein the processor is further configured to:
generate haptic feedback based upon an additional force measurement corresponding to the touch location, the additional force measurement having a second magnitude greater than the first magnitude.

8. The system of claim 1, wherein the plurality of sensors include at least one of a touch sensor and a force sensor.

9. The system of claim 1, further comprising:
an orientation sensor for sensing a rotation of a display; and
wherein the processor is further configured to update the at least one user interface element for the rotation of a display only if the orientation sensor senses the rotation and the plurality of touch locations changes.

10. A method, comprising:
receiving a plurality of force measurements from a plurality of sensors;
identifying a plurality of touch locations based on the plurality of force measurements; and
providing at least one user interface element based on the plurality of touch locations.

11. The method of claim 10, wherein the plurality of touch locations include at least one of a device edge and a device back opposite to a display.

12. The method of claim 10, the providing the at least one user interface element further including:
determining a location and an orientation on a display for each of the at least one user interface element.

13. The method of claim 10, further comprising:
generating haptic feedback based on the plurality of touch locations.

14. The method of claim 10, wherein a touch location of the plurality of touch locations corresponds to a force measurement from at least one sensor of the plurality of sensors, the force measurement having a first magnitude and wherein the method further includes:
updating the at least one user interface element based upon an additional force measurement corresponding to the touch location, the additional force measurement having a second magnitude greater than the first magnitude.

15. The method of claim 14, wherein the second magnitude exceeds at least one of an absolute threshold and a relative threshold equal to the first magnitude added to a first threshold.

16. The method of claim 10, wherein a touch location of the plurality of touch locations corresponds to a force measurement from at least one sensor of the plurality of sensors, the force measurement having a first magnitude and wherein the method further includes:
generating haptic feedback based upon an additional force measurement corresponding to the touch location, the additional force measurement having a second magnitude greater than the first magnitude.

17. The method of claim 10, wherein the plurality of sensors include at least one of a touch sensor and a force sensor.

18. The method of claim 10, further comprising:
updating the at least one user interface element for a rotation of a display only if an orientation sensor senses the rotation and the plurality of touch locations changes.
